(19) United States
(12) Patent Application Publication
(10) Pub. No.: US 2010/0001663 A1
(43) Pub. Date: Jan. 7, 2010

(54) Light source driving circuit with over-voltage protection

(76) Inventors: Nian-Tzu Wu, Taipei City (TW); Dong-Min Chen, Taipei County (TW); Sheng-Shou Wang, Taichung County (TW)

Correspondence Address: NORTH AMERICA INTELLECTUAL PROPERTY CORPORATION, P.O. BOX 506, MERRIFIELD, VA, 22116, US

(21) Appl. No.: 12/257,398

(22) Filed: Oct. 24, 2008

(30) Foreign Application Priority Data
Jul. 2, 2008 (TW) 097124874

(51) Int. Cl. H05B 41/36

(52) U.S. Cl. 315/308

(57) ABSTRACT

An over-voltage protection circuit clamps an output voltage of a light source driving circuit. The over-voltage protection circuit includes a transistor and two resistors. When the load of the light source driving circuit is broken, the over-voltage protection circuit utilizes the current generated from the error amplifier in order to enter the transistor into saturation region and accordingly generates a fixed gate voltage. The fixed gate voltage is utilized to clamp the output voltage of the light source driving circuit through the two resistors.

### BACKGROUND OF THE INVENTION

1. Field of the Invention

The present invention relates to a light source driving circuit utilizing voltage boosting for driving the Light Emitting Diode (LED), and more particularly, to a voltage boosting driving circuit having over-voltage protection in order to avoid outputting voltages exceeding a predetermined value, causing damages to the related circuits.

2. Description of the Prior Art

Please refer to FIG. 1. FIG. 1 is a diagram illustrating a conventional light source driving circuit 100. The light source driving circuit 100 is used to drive a load 110. The light source driving circuit 100 uses voltage boosting to drive the load 110. The load 110 comprises a plurality of LEDs connected in series. The load 100 receives the voltage V_{OUT} and the current I_{LOAD} outputted from the light source driving circuit 100 for providing light accordingly. The method for voltage boosting of the light source driving circuit 100 is well-known in the art and the detailed description is explained hereinafter.

The light source driving circuit 100 comprises a capacitor C₁, a diode D₁, an inductor L₁, a switch Q₁, a feedback resistor R_{FB}, a duty ratio regulator 120, an error amplifier 130, and a compensation circuit 140. The diode D₁ can be a Schottky diode. The switch Q₁ can be an N channel Metal Oxide Semiconductor (NMOS) transistor, and the switch Q₁ will be named as the transistor Q₁ below.

The duty ratio regulator 120 is used to generate a switch controlling signal S_{PWM} according to the error amplifier 130 and the compensation circuit 140. The duty ratio regulator 120 comprises a saw-tooth waveform generator 121 and a comparator 122. The saw-tooth waveform generator 121 is utilized to generate a saw-tooth waveform Vₛ. The comparator 122 comprises a positive input terminal, a negative input terminal, and an output terminal. The saw-tooth waveform generator 121 is electrically connected to the negative input terminal of the comparator 122 for inputting the saw-tooth waveform Vₛ to the comparator 122. The comparator 122 outputs the switch controlling signal S_{PWM} by comparing the signal voltage levels between the positive input terminal and negative input terminal of the comparator 122.

The error amplifier 130 comprises a positive input terminal, a negative input terminal, and an output terminal. According to the voltage level difference between signals received on the positive input terminal and the negative input terminal of the error amplifier 130, the error amplifier 130 outputs an error current I_{X} to the output terminal of the error amplifier 130. The magnitude and polarity of the error current I_{X} are related to the voltage level difference between signals received on the positive input terminal and the negative input terminal of the error amplifier 130.

The compensation circuit 140 comprises a resistor R_{X} and a capacitor C_{X}. The first terminal of the capacitor C_{X} is electrically connected to the second terminal of the resistor R_{X}, and the second terminal of the capacitor C_{X} is electrically connected to the ground terminal. The first terminal of the resistor R_{X} is electrically connected to the output terminal of the error amplifier 130 for receiving the error current I_{X} and the second terminal of the resistor R_{X} is connected to the first terminal of the capacitor C_{X}. The compensation circuit 140, comprised of the resistor R_{X} and the capacitor C_{X}, receives the error current I_{X} from the error amplifier 130, to adjust the duty voltage V_{DUTY}. In other words, when the error current I_{X} outputted from the error amplifier 130 is positive, the duty voltage V_{DUTY} increases (charges the resistor R_{X} and the capacitor C_{X}). Instead, when the error current I_{X} outputted from the error amplifier 130 is negative, the duty voltage V_{DUTY} declines (discharges the resistor R_{X} and the capacitor C_{X}).

The first terminal of the inductor L₁ is electrically connected to an input voltage source and the second terminal of the inductor L₁ is electrically connected to the second terminal (drain) of the transistor Q₁. The inductor L₁ is used to receive the input voltage V_{IN} of the input voltage source.

The second terminal (drain) of the transistor Q₁ is electrically connected to the second terminal of the inductor L₁ and the first terminal (source) of the transistor Q₁ is electrically connected to the ground. The control terminal (gate) of the transistor is electrically connected to the duty ratio regulator 120 for receiving the switch controlling signal S_{PWM}. More particularly, the control terminal (gate) of the transistor Q₁ is electrically connected to the output of the duty ratio regulator 120 for receiving the switch controlling signal S_{PWM}. When the switch controlling signal S_{PWM} is logic “0” (the voltage level is low), the transistor Q₁ is turned off, which implies the first terminal (source) and the second terminal (drain) of the transistor Q₁ are not electrically connected. When the switch controlling signal S_{PWM} is logic “1” (the voltage level is high), the transistor Q₁ is turned on, which implies the first terminal (source) and the second terminal (drain) of the transistor Q₁ are electrically connected.

The positive terminal of the diode D₁ is electrically connected to the second terminal of the inductor L₁ and the first terminal of the transistor Q₁. The negative terminal of the diode D₁ is electrically connected to the first terminal of the capacitor C₁.

The first terminal of the capacitor C₁ is electrically connected to the negative terminal of the diode D₁ and the second terminal of the capacitor C₁ is electrically connected to the ground terminal. The first terminal of the capacitor C₁ is utilized as the output terminal of the light source driving circuit 100 for outputting the voltage V_{OUT}.

The first terminal of the load 110 is electrically connected to the output terminal (the first terminal of the capacitor C₁) of the light source driving circuit 100. The second terminal of the load 110 is electrically connected to the first terminal of the feedback resistor R_{FB}. The load 110 receives the output voltage V_{OUT} and the load current I_{LOAD} accordingly passes.

The first terminal of the feedback resistor R_{FB} is electrically connected to the second terminal of the load 110 and the negative input terminal of the error amplifier 130. The second terminal of the feedback resistor R_{FB} is electrically connected to the ground terminal. The feedback resistor R_{FB} is used to receive the load current I_{LOAD}. The feedback resistor R_{FB} converts the load current I_{LOAD} to the feedback voltage V_{FB} outputted to the negative terminal of the error amplifier 130. Hence, according to the voltage V_{FB}, the error amplifier 130 determines the magnitude of the load current I_{LOAD} of the load 110.

The positive input terminal of the error amplifier 130 is electrically connected to a reference voltage source to receive a reference voltage V_{REF}. The negative input terminal of the error amplifier 130 is electrically connected to the first terminal of the feedback resistor R_{FB} to receive the feedback voltage V_{FB}. The output terminal of the error amplifier 130 is electrically connected to the duty ratio regulator 120 and the compensation circuit 140. More particularly, the output terminal of the error amplifier 130 is electrically connected to the negative input terminal of the comparator 122 of the duty ratio regulator 120 and the first terminal of the resistor R_{X} of the compensation circuit 140. According to the difference between the reference voltage V_{REF} and the feedback voltage V_{FB}, the error amplifier 130 outputs a corresponding proportional error current I_{X}. More particularly, when the feedback voltage V_{FB} is smaller than the reference voltage V_{REF}, the error amplifier 130 outputs the positive error current I_{X} and the magnitude of the error current I_{X} is positively proportional to the difference between the feedback voltage V_{FB} and the reference voltage V_{REF}. The duty voltage V_{DUTY} is increased (decrease the duty ratio to increase the output voltage V_{OUT}) by charging the compensation circuit 140 accordingly. Instead, when the feedback voltage V_{FB} is larger than the reference voltage V_{REF}, the error amplifier 130 outputs the negative error current I_{X} and the magnitude of the error current I_{X} is positively proportional to the difference between the feedback voltage V_{FB} and the reference voltage V_{REF}. The duty voltage V_{DUTY} is decreased (increase the duty ratio to decrease the output voltage V_{OUT}) by discharging the compensation circuit 140. The error current I_{X} is calculated as the formula below: I_{X}=G₁₃₀×(V_{REF}−V_{FB}) . . . (1), where G₁₃₀ represents the transduction gain of the error amplifier 130.

Yet the magnitude of the error current I_{X} is still limited by the design of the error amplifier 130. For instance, the maximum error current output limit of the error amplifier is I_{MAX} and as long as the calculated error current does not exceed I_{MAX}, formula (1) can be used to calculate the magnitude of the error current.

In the duty ratio regulator 120, the comparator 122 receives the duty voltage V_{DUTY} and the saw-tooth waveform V_{S}. When the duty voltage V_{DUTY} is higher than the saw-tooth waveform V_{S}, the comparator 122 outputs logic “0” (low voltage level) as the switch controlling signal S_{PWM}. When the duty voltage V_{DUTY} is lower than the saw-tooth waveform V_{S}, the comparator 122 outputs logic “1” (high voltage level) as the switch controlling signal S_{PWM}.

Therefore, when the feedback voltage V_{FB} is higher than the reference voltage V_{REF}, the load current I_{LOAD} is higher than the default value and the error amplifier 130 outputs the error current I_{X} to the compensation circuit 140 to decrease the magnitude of the duty voltage V_{DUTY}. Hence, the comparator 122 compares the decreased duty voltage V_{DUTY} and the saw-tooth waveform Vₛ to output a switch controlling signal S_{PWM} with a higher duty ratio. More particularly, The period of the transistor Q₁ being turned on is decreased according to a higher duty ratio of the switch controlling signal S_{PWM}. Hence the output voltage V_{OUT} of light source driving circuit 100 is decreased and the magnitude of the load current I_{LOAD} is decreased as well and back to the default value.

Instead, when the feedback voltage V_{FB} is lower than the reference voltage V_{REF}, the load current I_{LOAD} is lower than the default value and the error amplifier 130 outputs the error current I_{X} to the compensation circuit 140 to increase the magnitude of the duty voltage V_{DUTY}. Hence, the comparator 122 compares the decreased duty voltage V_{DUTY} and the saw-tooth waveform Vₛ to output a switch controlling signal S_{PWM} with a lower duty ratio. More particularly, The period of the transistor Q₁ being turned on is increased according to a lower duty ratio of the switch controlling signal S_{PWM}. Hence the output voltage V_{OUT} of light source driving circuit 100 is increased and the magnitude of the load current I_{LOAD} is increased as well and back to the default value.

Please refer to FIG. 2. FIG. 2 is a diagram illustrating an abnormal load situation under the structure of the conventional light source driving circuit 100. As shown in FIG. 2, the load 110 comprises a plurality of LEDs connected in series. When one of the plurality of the LEDs is soldered improperly or the interconnection of the plurality of the LEDs is broken (disconnected), open circuit forms between the output terminal and the feedback resistor R_{FB} of the light source driving circuit 100, and consequently the load current I_{LOAD} is not detected. Meanwhile, the lack of the load current I_{LOAD} means the feedback voltage V_{FB} is “0” volt and the error amplifier 130 determines that the load current I_{LOAD} is insufficient and continues to output the error current I_{X} to increase the duty voltage V_{DUTY}. Hence, after comparing the saw-tooth waveform V_{S} with the comparator 122 of the duty ratio regulator 120, the duty ratio of the outputted switch controlling signal S_{PWM} will continue to decrease. Under such condition, due to the large difference between the feedback voltage V_{FB} and the reference voltage V_{REF}, the error current I_{X} outputted from the error amplifier 130 equals the maximum I_{MAX}. Hence, after the comparator 122 of the duty ratio regulator has compared with the saw-tooth waveform V_{S}, the duty ratio of the output switch controlling signal S_{PWM} continues to decline. In other words, the output voltage V_{OUT} of the light source driving circuit 100 also continues to rise and the excessive voltage damages the transistor Q₁.

Please refer to FIG. 3. FIG. 3 is a timing diagram illustrating the relationship between the duty voltage V_{DUTY}, the saw-tooth waveform V_{S}, the switch controlling signal S_{PWM}, and the output voltage V_{OUT}, of an abnormal load situation under the structure of the conventional light source driving circuit 100. As shown in FIG. 3, V_{LM} is the maximum voltage tolerance limit (source-drain voltage differential V_{DS}) of the transistor Q₁. As shown in FIG. 3, when the duty voltage V_{DUTY} continues to increase, the output (the switch controlling signal S_{PWM}) of the comparator 122 according to the duty voltage V_{DUTY} and the saw-tooth waveform V_{S} indicates the duty ratio continues to decline from 90%, 85%, 65%, 45%, 30%, 20%, 5%, 4%, 3%, to the lowest 0%. Hence the output voltage V_{OUT} continues to rise to exceed the voltage difference (V_{DS}) the transistor Q₁ can tolerate, resulting in damaging the transistor Q₁ and causing inconvenience to the user.

### SUMMARY OF THE INVENTION

The present invention provides a light source driving circuit with over-voltage protection. The light source driving circuit comprises an input terminal for receiving an input voltage, an inductor electrically connected to the input terminal, a diode electrically connected to the inductor, an output terminal electrically connected to the diode for outputting an output voltage, a load, a feedback resistor electrically connected between the second terminal of the load and a ground terminal, an error amplifier, a duty ratio regulator electrically connected to the output terminal of the error amplifier for outputting a switch controlling signal, a switch, and an over-voltage protection circuit. The load comprises a first terminal electrically connected to the output terminal of the light source driving circuit, and a second terminal. The error amplifier comprises a positive terminal for receiving a reference voltage, a negative terminal electrically connected to the feedback resistor for receiving a feedback voltage, and an output terminal. The error amplifier outputs an error current according to difference between the reference voltage and the feedback voltage through the output terminal of the error amplifier. The switch comprises a first terminal electrically connected to the inductor, a second terminal electrically connected to the ground terminal, and a control terminal electrically connected to the duty ratio regulator for electrically connecting the first terminal of the switch to the second terminal of the switch according to the switch controlling signal. The over-voltage protection circuit comprises a transistor, a first voltage dividing resistor electrically connected between the output terminal of the light source driving circuit and the control terminal of the transistor of the over-voltage protection circuit, and a second voltage dividing resistor electrically connected to the control terminal of the transistor of the over-voltage protection circuit and the ground terminal. The transistor comprises a first terminal electrically connected to the output terminal of the error amplifier for receiving the error current, a second terminal electrically connected to the ground terminal, and a control terminal for outputting a control voltage according to the error current. Wherein the control voltage clamps the output voltage of the light source driving circuit according to resistances of the first and the second voltage dividing resistors.

The present invention further provides an over-voltage protection circuit for clamping the output voltage of a light source driving circuit when a load is in abnormal condition. The light source driving circuit comprises an input terminal, an inductor, a diode, an output terminal, a load, a capacitor, a feedback resistor, an error amplifier, a duty ratio regulator, a switch and a compensation circuit. The output terminal of the light source driving circuit is utilized to receive an input voltage. The capacitor is electrically connected to the input terminal of the light source driving circuit. The diode is electrically connected to the capacitor. The output terminal of the light source driving circuit is electrically connected to the diode for outputting the output voltage. The load comprises a first terminal electrically connected to the output terminal of the light source driving circuit, and a second terminal. The feedback resistor is electrically connected between the second terminal of the load and the ground terminal. The error amplifier comprises a positive input terminal for receiving a reference voltage, a negative input terminal electrically connected to the feedback resistor for receiving a feedback voltage, and an output terminal. The error amplifier outputs an error current according to the difference between the reference voltage and the feedback voltage. The compensation circuit is electrically connected between the output terminal of the amplifier and the ground terminal for generating a duty voltage according to the error current generated from the error amplifier. The duty ratio regulator comprises a comparator and a saw-tooth waveform generator for generating a saw-tooth waveform. The comparator comprises a positive input terminal electrically connected to the saw-tooth waveform generator for receiving the saw-tooth waveform, a negative input terminal electrically connected to the output terminal of the error amplifier for receiving the duty voltage, and an output terminal electrically connected to the control terminal of the switch for outputting a switch controlling signal according to comparing result of voltages received on the positive input terminal of the comparator and the negative input of the comparator. The switch comprises a first terminal electrically connected to the inductor, a second terminal electrically connected to the ground terminal and a control terminal electrically connected to the duty ratio regulator for electrically connecting the second terminal of the switch to the first terminal of the switch according to the switch controlling signal. The over-voltage protection circuit comprises a transistor, a first voltage dividing resistor electrically connected between the output terminal of the light source driving circuit and the control terminal of the transistor of the over-voltage protection circuit, and a second voltage dividing resistor electrically connected between the control terminal of the transistor of the over-voltage protection circuit and the ground terminal. The transistor comprises a first terminal electrically connected to the output terminal of the error amplifier for receiving the error current, a second terminal electrically connected to the ground terminal, and a control terminal for outputting a control voltage according to the error current. Wherein the control voltage clamps the output voltage of the light source driving circuit according to resistances of the first voltage dividing resistor and the second voltage dividing resistor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional light source driving circuit.

FIG. 2 is a diagram illustrating an abnormal load situation under the structure of the conventional light source driving circuit.

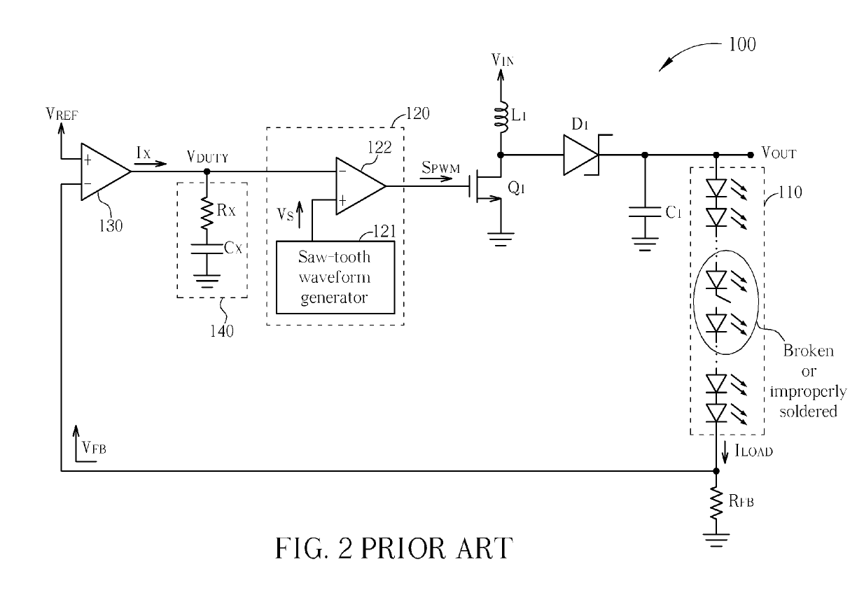

FIG. 3 is a timing diagram illustrating the relationship between the duty voltage, the saw-tooth waveform, the switch controlling signal, and the output voltage of an abnormal load situation under the structure of the conventional light source driving circuit.

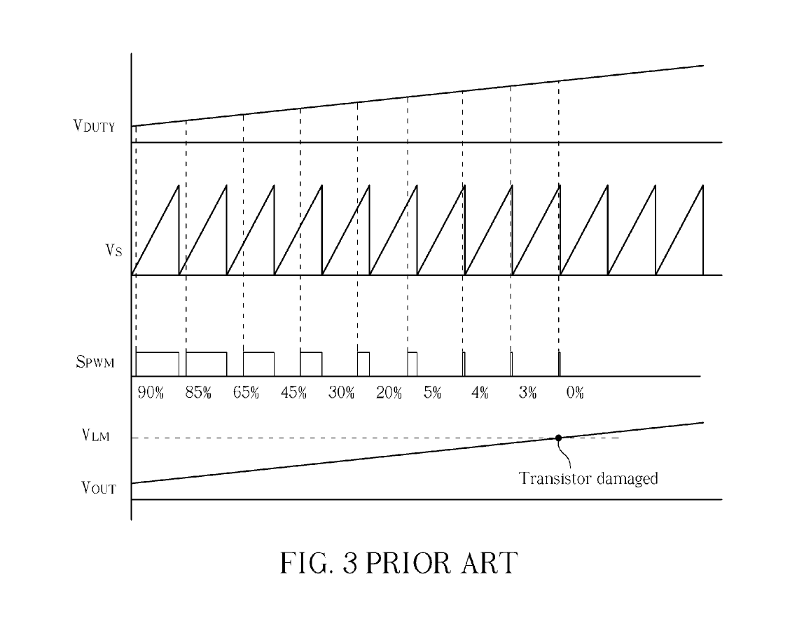

FIG. 4 is a diagram illustrating the light source driving circuit with over-voltage protection of the present invention.

FIG. 5 is a diagram illustrating the load in the abnormal condition, under the structure of the light source driving circuit with the over-voltage protection of the present invention.

FIG. 6 is a timing diagram illustrating the relationship between the duty voltage, the saw-tooth waveform, the switch controlling signal, and the output voltage when the load is in the abnormal condition under the structure of the light source driving circuit with the over-voltage protection.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . .” Also, the term “electrically connect” is intended to mean either an indirect or direct electrical connection. Accordingly, if one device is coupled to another device, that connection may be through a direct electrical connection, or through an indirect electrical connection via other devices and connections.

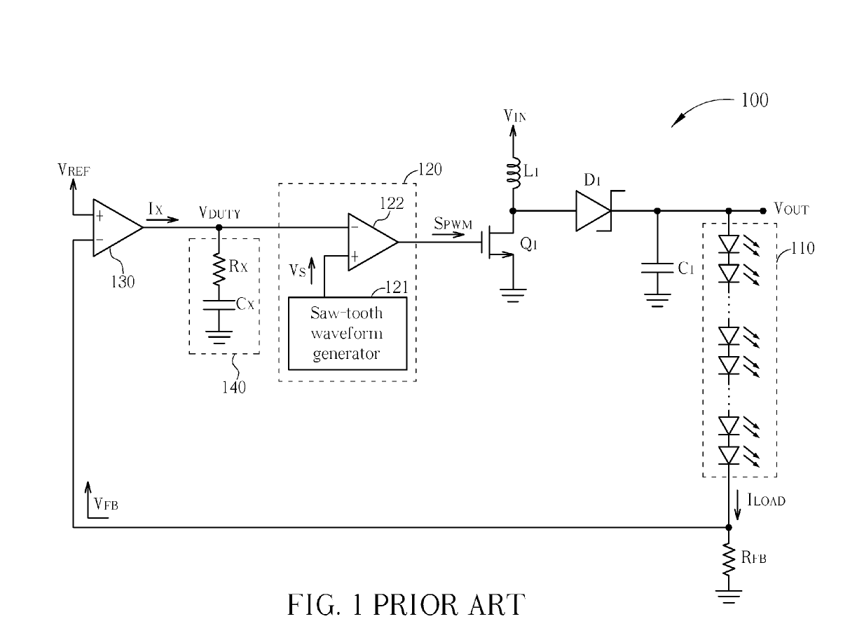

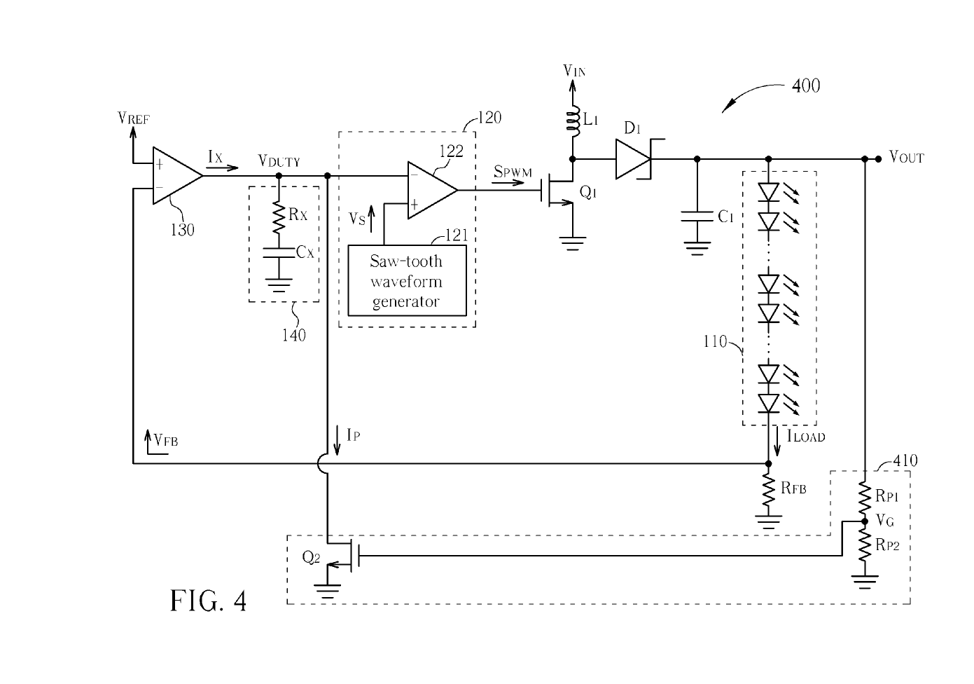

Please refer to FIG. 4. FIG. 4 is a diagram illustrating the light source driving circuit 400 with over-voltage protection of the present invention. The light source driving circuit 400 of FIG. 4 and FIG. 1 are similar hence the identical parts and relative functionalities are omitted in this section. As shown in FIG. 4, the light source driving circuit 400 of the present invention adds an over-voltage protection circuit 410. The over-voltage protection circuit 410 is utilized for limiting the magnitude of the output voltage V_{OUT} of the light source driving circuit 400 in order to prevent damaging the transistor Q₁ when the load 110 is in abnormal condition. The over-voltage protection circuit 410 is explained in detail hereinafter.

The over-voltage protection circuit 410 comprises a transistor Q₂, two voltage dividing resistors R_{P1} and R_{P2}. The transistor Q₂ can be an NMOS transistor. The first terminal of the voltage dividing resistor R_{P1} is electrically connected to the output terminal of the light source driving circuit 400 and the first terminal of the load 110. The second terminal of the voltage dividing resistor R_{P1} is electrically connected to the first terminal of the voltage dividing resistor R_{P2} and the control terminal (gate) of the transistor Q₂. The first terminal of the voltage dividing resistor R_{P2} is electrically connected to the second terminal of the voltage dividing resistor R_{P1} and the control terminal (gate) of the transistor Q₂. The second terminal of the voltage dividing resistor R_{P2} is electrically connected to the ground terminal. The first terminal (source) of the transistor Q₂ is electrically connected to the ground terminal. The second terminal (drain) of the transistor Q₂ is electrically connected to the output terminal of the error amplifier 130, the first terminal of the resistor R_{X} of the compensation circuit 140, and the negative input terminal of the comparator 122 of the duty ratio regulator 120.

The resistances of the voltage dividing resistors R_{P1} and R_{P2} can be designed appropriately, hence under normal condition, the gate terminal voltage (control voltage) V_{G} divided from the output voltage V_{OUT} keeps the transistor Q₂ turned on.

Under normal operation, when the error amplifier 130 determines the load current I_{LOAD} is smaller than the default value, the error current I_{X} charges the compensation circuit 140 to decrease the duty voltage V_{DUTY}. Meanwhile, due to the drain terminal of the transistor Q₂ is electrically connected to the output terminal of the error amplifier 130, a partial current I_{P} (will be named as drain current below) of the error current I_{X} is directed to the drain of the transistor Q₂. When the directed drain current I_{P} enables the transistor Q₂ to enter the saturation region. The gate voltage V_{G} of the transistor Q₂ is then controlled by the drain current I_{P}. In the saturation region, the relationship between the gate voltage V_{G} and the drain current I_{P} can be expressed by the formula below:

I_{P}=K×(V_{G}−V_{T})² . . . (2), where K represents the process variable of the transistor Q₂.

Hence, due to the gate voltage V_{G} is controlled by the drain current I_{P} when the transistor Q₂ is in the saturation region, the output voltage V_{OUT} of the light source driving circuit 400 is clamped within a default range by the gate voltage V_{G} (or the drain current I_{P}). Also, the process variable K needs to be designed appropriately to ensure the error current I_{P} outputted from the error amplifier 130 to allow the transistor Q₂ to enter the saturation region.

When the capacitor C_{X} of the compensation circuit 140 has completed charging, the error current I_{X} outputted from the output terminal of the error amplifier 130 will no longer flow into the compensation circuit 140, but into the drain of the transistor Q₂. In other words, the error current I_{X} equals to the drain current I_{P}.

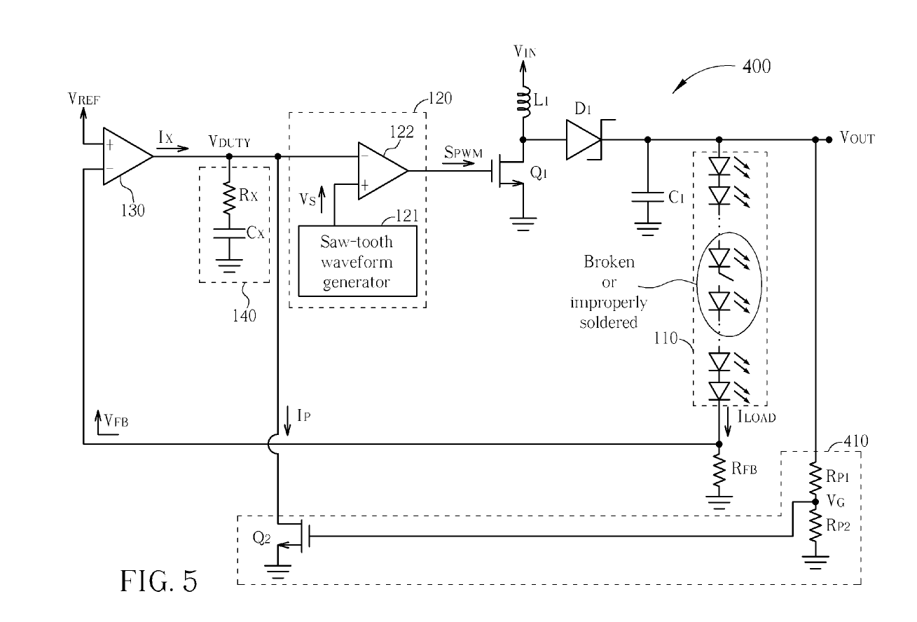

Please refer to FIG. 5. FIG. 5 is a diagram illustrating the load 110 in the abnormal condition, under the structure of the light source driving circuit 400 with the over-voltage protection of the present invention. As shown in FIG. 5, the load 110 comprises a plurality of LEDs connected in series. When one of the plurality of the LEDs is soldered improperly or the interconnection of the plurality of the LEDs is broken (disconnected), open circuit forms between the output terminal and the feedback resistor R_{FB} of the light source driving circuit 400, and consequently the load current I_{LOAD} is not detected. Meanwhile, the lack of the load current I_{LOAD} means the feedback voltage V_{FB} is “0” volt so that the error amplifier 130 determines that the load current I_{LOAD} is insufficient and accordingly continues to output the error current I_{X} to increase the duty voltage V_{DUTY}. In this way, after the comparator 122 of the duty ratio regulator 120 compares the increased duty voltage V_{DUTY} and the saw-tooth waveform V_{S}, the duty ratio of the outputted switch controlling signal S_{PWM} will continue to increase. Under such condition, due to the large difference between the feedback voltage V_{FB} and the reference voltage V_{REF}, the error current I_{X} outputted from the error amplifier 130 equals the maximum I_{MAX}. In other words, after the capacitor C_{X} of the compensation circuit 140 has completed charging, the drain current I_{P} flowing into the drain of the transistor Q₂ equals I_{MAX}. Hence, when abnormal conditions (improper soldering or disconnection) occurs to the load 110, the drain current I_{P} flowing into the drain of the transistor Q₂ equals to the maximum output error current I_{MAX} of the error amplifier 130. When the transistor Q₂ is in the saturation region, the gate voltage V_{G} of the transistor Q₂ can be calculated from the drain current I_{MAX}. The calculated gate voltage V_{G} is clamped by the drain current I_{MAX} according to formula (2). The magnitude of the limitation of the output voltage V_{OUT} can then be calculated from the voltage dividing resistor R_{P1} and R_{P2}, and the gate voltage V_{G}. In other words, the output voltage V_{OUT} of the light source driving circuit 400 is clamped by the gate voltage V_{G} and the magnitude of the output voltage V_{OUT} can be calculated from the formula below:

V_{OUT}=V_{G}×(R_{P1}+R_{P2})/R_{P2} (3).

Hence, the output voltage V_{OUT} of the light source driving circuit 400 will not rise infinitely but be clamped to a fixed voltage level. The transistor Q₁ is then prevented from the risk of being damaged. However, the resistances of the voltage dividing resistors, R_{P1} and R_{P2}, need to be designed appropriately to ensure the final clamped output voltage V_{OUT} is lower than the voltage tolerance of the transistor Q₁.

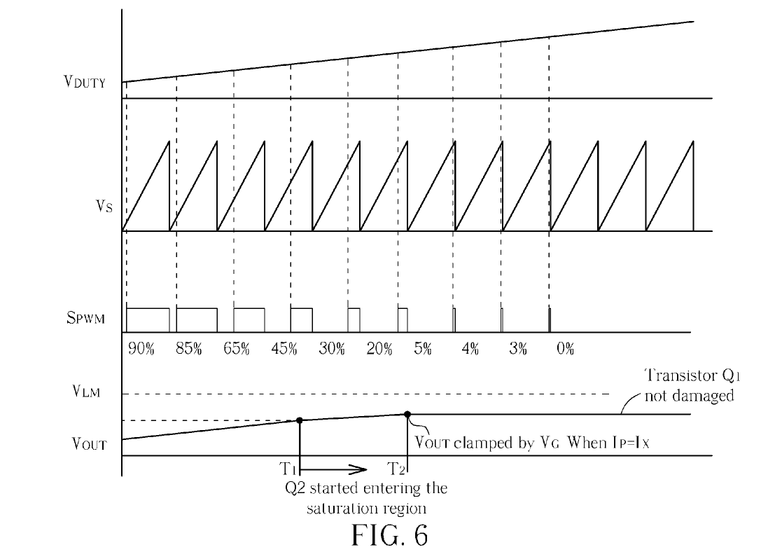

Please refer to FIG. 6. FIG. 6 is a timing diagram illustrating the relationship between the duty voltage V_{DUTY}, the saw-tooth waveform V_{S}, the switch controlling signal S_{PWM}, and the output voltage V_{OUT} when the load is in the abnormal condition under the structure of the light source driving circuit 400 with the over-voltage protection. As shown in FIG. 6, V_{LM} is the maximum voltage tolerance limit of the transistor Q₁. As shown in FIG. 6, when the duty voltage V_{DUTY} continues to increase, the output (the switch controlling signal S_{PWM}) of the comparator 122 according to the duty voltage V_{DUTY} and the saw-tooth waveform V_{S} indicates the duty ratio continues to decline from 90%, 85%, 65%, 45%, 30%, 20%, 5%, 4%, 3%, to the lowest 0%. Hence although the duty ratio of the switch controlling signal S_{PWM} continues to decline, as long as the transistor Q₂ has entered the saturation region (as shown in FIG. 6, after the time T₁), the gate voltage V_{G} is then affected by the drain current I_{P} and the output voltage V_{OUT} is controlled according to formula (3). As shown in FIG. 6, after the time T₂, the compensation circuit 140 has completed charging and all error current I_{X} are flew into the drain of the transistor Q₂. According to prior description, after the time T₂, the drain current I_{P} of the transistor Q₂ equals to I_{MAX} (fixed value), and according to formula (3), the output voltage V_{OUT} is clamped in the meanwhile. Hence, the output voltage V_{OUT} will not exceed the voltage tolerance limit (V_{LM}) of the transistor Q₁ and the transistor Q₁ is prevented from being damaged; hence providing huge convenience to the user.

Those skilled in the art will readily observe that numerous modifications and alterations of the device and method may be made while retaining the teachings of the invention.

What is claimed is:

1. A light source driving circuit with over-voltage protection, the light source driving circuit comprising:
an input terminal for receiving an input voltage;
an inductor electrically connected to the input terminal;
a diode electrically connected to the inductor;
an output terminal electrically connected to the diode for outputting an output voltage;
a load, comprising:
a first terminal electrically connected to the output terminal of the light source driving circuit; and
a second terminal;
a feedback resistor electrically connected between the second terminal of the load and a ground terminal;
an error amplifier, comprising:
a positive terminal for receiving a reference voltage;
a negative terminal electrically connected to the feedback resistor for receiving a feedback voltage; and
an output terminal, the error amplifier outputting an error current according to difference between the reference voltage and the feedback voltage through the output terminal of the error amplifier;
a duty ratio regulator electrically connected to the output terminal of the error amplifier for outputting a switch controlling signal;
a switch, comprising:
a first terminal electrically connected to the inductor;
a second terminal electrically connected to the ground terminal; and
a control terminal electrically connected to the duty ratio regulator for electrically connecting the first terminal of the switch to the second terminal of the switch according to the switch controlling signal; and
an over-voltage protection circuit, comprising:
a transistor, comprising:
a first terminal electrically connected to the output terminal of the error amplifier for receiving the error current;
a second terminal electrically connected to the ground terminal; and
a control terminal for outputting a control voltage according to the error current;
a first voltage dividing resistor electrically connected between the output terminal of the light source driving circuit and the control terminal of the transistor of the over-voltage protection circuit; and
a second voltage dividing resistor electrically connected to the control terminal of the transistor of the over-voltage protection circuit and the ground terminal;
wherein the control voltage clamps the output voltage of the light source driving circuit according to resistances of the first and the second voltage dividing resistors.

2. The light source driving circuit of claim 1, wherein the load is a plurality of Light Emitting Diodes (LED) connected in series.

3. The light source driving circuit of claim 1, wherein the switch is an N-channel Metal Oxide Semiconductor (NMOS) transistor.

4. The light source driving circuit of claim 1, wherein the transistor of the over-voltage protection circuit is an NMOS transistor.

5. The light source driving circuit of claim 1, further comprising a capacitor electrically connected between the diode and the ground terminal.

6. The light source driving circuit of claim 1, further comprising a compensation circuit electrically connected between the output terminal of the error amplifier and the ground terminal, for generating a duty voltage according to the error current generated from the error amplifier.

7. The light source driving circuit of claim 6, wherein the compensation circuit comprising:
a resistor electrically connected to the output terminal; and
a capacitor electrically connected between the resistor of the compensation circuit and the ground terminal.

8. The light source driving circuit of claim 7, wherein the duty ratio regulator comprising:
a saw-tooth waveform generator for generating a saw-tooth waveform; and
a comparator, comprising:
a positive input terminal electrically connected to the saw-tooth waveform generator for receiving the saw-tooth waveform;
a negative input terminal electrically connected to the output terminal of the error amplifier for receiving the duty voltage; and
an output terminal electrically connected to the control terminal of the switch for outputting a switch controlling signal according to comparing result of voltages received on the positive input terminal of the comparator and the negative input terminal of the comparator.

9. The light source driving circuit of claim 1, wherein the transistor of the over-voltage protection circuit operates in the saturation region according to the error current.

10. The light source driving circuit of claim 1, wherein the resistances of the first voltage dividing resistor and the second voltage dividing resistor are set according to value of voltage tolerance of the switch.

11. The light source driving circuit of claim 1, wherein the error current outputted from the error amplifier has a maximum value.

12. The light source driving circuit of claim 11, wherein the process variable of the transistor of the over-voltage protection circuit is set according to the maximum value of the error current, to ensure the transistor to operate in the saturation region according to the error current.

13. An over-voltage protection circuit for clamping the output voltage of a light source driving circuit when a load is in abnormal condition, the light source driving circuit comprising an input terminal, an inductor, a diode, an output terminal, the load, a capacitor, a feedback resistor, an error amplifier, a duty ratio regulator, a switch and a compensation circuit, the output terminal of the light source driving circuit being utilized to receive an input voltage, the capacitor electrically connected to the input terminal of the light source driving circuit, the diode electrically connected to the capacitor, the output terminal of the light source driving circuit electrically connected to the diode for outputting the output voltage, the load comprising a first terminal electrically connected to the output terminal of the light source driving circuit, and a second terminal, the feedback resistor electrically connected between the second terminal of the load and the ground terminal, the error amplifier comprising a positive input terminal for receiving a reference voltage, a negative input terminal electrically connected to the feedback resistor for receiving a feedback voltage, and an output terminal, the error amplifier outputting an error current according to the difference between the reference voltage and the feedback voltage, the compensation circuit electrically connected between the output terminal of the amplifier and the ground terminal for generating a duty voltage according to the error current generated from the amplifier, the duty ratio regulator comprising a saw-tooth waveform generator for generating a saw-tooth waveform and a comparator, the comparator comprising a positive input terminal electrically connected to the saw-tooth waveform generator for receiving the saw-tooth waveform, a negative input terminal electrically connected to the output terminal of the error amplifier for receiving the duty voltage, and an output terminal electrically connected to the control terminal of the switch for outputting a switch controlling signal according to comparing result of voltages received on the positive input terminal of the comparator and the negative input of the comparator, the switch comprising a first terminal electrically connected to the inductor, a second terminal electrically connected to the ground terminal and a control terminal electrically connected to the duty ratio regulator for electrically connecting the second terminal of the switch to the first terminal of the switch according to the switch controlling signal, the over-voltage protection circuit comprising:
a transistor, comprising:
a first terminal electrically connected to the output terminal of the error amplifier for receiving the error current;
a second terminal electrically connected to the ground terminal; and
a control terminal for outputting a control voltage according to the error current;
a first voltage dividing resistor electrically connected between the output terminal of the light source driving circuit and the control terminal of the transistor of the over-voltage protection circuit; and
a second voltage dividing resistor electrically connected between the control terminal of the transistor of the over-voltage protection circuit and the ground terminal;
wherein the control voltage clamps the output voltage of the light source driving circuit according to resistances of the first voltage dividing resistor and the second voltage dividing resistor.

14. The over-voltage protection circuit of claim 13, wherein the load is a plurality of LEDs connected in series.

15. The over-voltage protection circuit of claim 13, wherein the switch is an NMOS transistor.

16. The over-voltage protection circuit of claim 13, wherein the transistor of the over-voltage protection circuit is an NMOS transistor.

17. The over-voltage protection circuit of claim 13, wherein the transistor of the over-voltage protection circuit operates in the saturation region according to the error current.

18. The over-voltage protection circuit of claim 13, wherein the resistances of the first voltage dividing resistor and the second voltage dividing resistor are set according to voltage tolerance of the switch.

19. The over-voltage protection circuit of claim 13, wherein the error current outputted form the error amplifier has a maximum value.

20. The over-voltage protection circuit of claim 19, wherein the process variable of the transistor of the over-voltage protection circuit is set according to the maximum value of the error current, to ensure the transistor can operate in the saturation region according to the error current.
